(19) United States
(12) Patent Application Publication
(10) Pub. No.: US 2022/0041501 A1
(43) Pub. Date: Feb. 10, 2022

(54) RESIN COMPOSITION, SECONDARY COATING MATERIAL FOR OPTICAL FIBER, OPTICAL FIBER, AND METHOD FOR PRODUCING OPTICAL FIBER

(71) Applicant: SUMITOMO ELECTRIC INDUSTRIES, LTD., Osaka-shi, Osaka (JP)

(72) Inventor: Katsushi HAMAKUBO, Osaka-shi, Osaka (JP)

(73) Assignee: SUMITOMO ELECTRIC INDUSTRIES, LTD., Osaka-shi, Osaka (JP)

(21) Appl. No.: 17/291,009

(22) PCT Filed: Jun. 10, 2020
(86) PCT No.: PCT/JP2020/022810

§ 371 Date: May 4, 2021

(30) Foreign Application Priority Data
Jun. 19, 2019 (JP) 2019-113476

(51) Int. Cl. C03C 25/1065; C08G 18/76; C08G 18/12; C08G 18/32; C08G 18/34; C08K 3/22; C09D 175/14; C03C 25/285; C03C 25/326; C03C 25/47; G02B 6/02

(52) U.S. Cl. CPC C03C 25/1065; C08G 18/7621; C08G 18/12; C08G 18/3206; C08G 18/348; C08G 18/341; C08K 2003/2227; C09D 175/14; C03C 25/285; C03C 25/326; C03C 25/47; G02B 6/02395; C08K 3/22

(57) ABSTRACT

A resin composition for coating an optical fiber is a resin composition comprising: a base resin containing an oligomer comprising urethane (meth)acrylate, a monomer, and a photopolymerization initiator; and hydrophobic aluminum oxide, wherein the content of the aluminum oxide is 1% by mass or more and 60% by mass or less based on the total amount of the resin composition.

### TECHNICAL FIELD

The present disclosure relates to a resin composition, a secondary coating material for an optical fiber, an optical fiber, and a method of manufacturing the optical fiber.

This application claims priority based on Japanese Patent Application No. 2019-113476 filed on Jun. 19, 2019, and incorporates all the contents described in the Japanese application.

### BACKGROUND ART

An optical fiber has generally a coating resin layer for protecting a glass fiber that is an optical transmission medium. In order to reduce an increase in transmission loss induced by micro-bend generated when lateral pressure is applied to the optical fiber, the optical fiber has been required to have excellent lateral pressure characteristics.

The coating resin layer can be formed by using an ultraviolet curable resin composition containing an oligomer, a monomer, a photopolymerization initiator and the like. For example, in Patent Literature 1, it is investigated to improve the lateral pressure characteristics of the optical fiber by forming a resin layer using an ultraviolet curable resin composition containing a filler made of synthetic silica as a raw material.

### CITATION LIST

### Patent Literature

[Patent Literature 1] JP 2014-219550 A

### SUMMARY OF INVENTION

A resin composition according to an aspect of the present disclosure is a resin composition comprising: a base resin containing an oligomer comprising urethane (meth)acrylate, a monomer, and a photopolymerization initiator; and hydrophobic aluminum oxide, wherein the content of the aluminum oxide is 1% by mass or more and 60% by mass or less based on the total amount of the resin composition.

### BRIEF DESCRIPTION OF DRAWING

FIG. 1 is a schematic cross-section diagram showing an example of the optical fiber according to the present embodiment.

### DESCRIPTION OF EMBODIMENTS

### Problem to be Solved by the Present Disclosure

A coating resin layer generally comprises a primary resin layer and a secondary resin layer. The resin composition forming the secondary resin layer is required to improve the lateral pressure characteristics of the optical fiber by increasing the Young's modulus. However, in the case of a resin composition containing a filler, filler precipitation may reduce the storage stability of the resin composition.

An object of the present disclosure is to provide a resin composition capable of producing an optical fiber having not only excellent storage stability but also excellent lateral pressure characteristics, and an optical fiber having excellent lateral pressure characteristics.

### Effects of the Present Disclosure

The present disclosure can provide a resin composition capable of producing an optical fiber having not only excellent storage stability but also excellent lateral pressure characteristics, and an optical fiber having excellent lateral pressure characteristics.

### DESCRIPTION OF EMBODIMENTS OF THE PRESENT DISCLOSURE

First, the contents of the embodiment of the present disclosure will be described by listing them. A resin composition according to an aspect of the present disclosure is a resin composition comprising: a base resin containing an oligomer comprising urethane (meth)acrylate, a monomer, and a photopolymerization initiator; and hydrophobic aluminum oxide, wherein the content of the aluminum oxide is 1% by mass or more and 60% by mass or less based on the total amount of the resin composition.

The aluminum oxide can increase the Young's modulus of the resin layer and release reaction heat when the resin composition is cured, thereby allowing stress in the resin layer during curing to be reduced. The aluminum oxide is contained within a certain range, thereby allowing formation of a smooth resin layer having excellent storage stability of the resin composition. An optical fiber having excellent lateral pressure characteristics can be prepared by using the resin composition according to the present embodiment as an ultraviolet curable resin composition for coating the optical fiber.

From the view point of forming a resin layer having a high Young's modulus, the average primary particle size of the aluminum oxide may be 5 nm or more and 800 nm or less.

Due to easy formation of a resin layer having a high Young's modulus, the above oligomer may further comprise epoxy (meth)acrylate.

The secondary coating material for the optical fiber according to an aspect of the present disclosure comprises the above resin composition. Using the resin composition according to the present embodiment for the secondary resin layer, the coating resin layer having excellent lateral pressure characteristics can be formed.

The optical fiber according to an aspect of the present disclosure comprises a glass fiber comprising a core and a cladding, a primary resin layer being in contact with a glass fiber and coating the glass fiber, and a secondary resin layer coating the primary resin layer, wherein the secondary resin layer comprises a cured product of the above resin composition. The content of aluminum oxide in the secondary resin layer is 1% by mass or more and 60% by mass or less based on the total amount of the secondary resin layer. The resin composition according to the present embodiment is applied to the secondary resin layer, allowing improvement in the lateral pressure characteristics of the optical fiber.

A method of manufacturing the optical fiber according to an aspect of the present disclosure comprises an application step of applying the above resin composition onto the outer periphery of a glass fiber composed of a core and a cladding and a curing step of curing the resin composition by irradiation with ultraviolet rays after the application step. This can produce an optical fiber having improved lateral pressure characteristics.

### DETAIL OF EMBODIMENT OF THE PRESENT DISCLOSURE

Specific examples of a resin composition and an optical fiber according to the present embodiment of the present disclosure will be described referring to the drawing as necessary. The present invention is not limited to these illustrations but is indicated by the claims and intended to include meanings equivalent to the claims and all modifications within the claims. In the following description, the same reference numerals are given to the same elements in the description of the drawing, and redundant explanations are omitted.

<Resin Composition>

The resin composition according to the present disclosure comprises: a base resin containing an oligomer comprising urethane (meth)acrylate, a monomer, and a photopolymerization initiator; and hydrophobic aluminum oxide.

(Aluminum Oxide)

The aluminum oxide (alumina) according to the present embodiment is hydrophobic alumina particles the surface of which has been subjected to hydrophobic treatment. The hydrophobic treatment according to the present embodiment is introduction of a hydrophobic group onto the surface of the aluminum oxide. Alumina produced by a gas phase method, a liquid phase method, or a deflagration method may be used as the aluminum oxide before the hydrophobic treatment. The aluminum oxide before the hydrophobic treatment typically has a hydroxyl group on the surface and is hydrophilic. The aluminum oxide having a hydrophobic group introduced has excellent dispersibility in the resin composition. The hydrophobic group may be a reactive group such as a (meth)acryloyl group or a non-reactive group such as a hydrocarbon group. In the case of the aluminum oxide having a reactive group, the resin layer having high Young's modulus is easy to form.

The alumina particles according to the present embodiment are dispersed in a dispersion medium. Using the alumina particles dispersed in the dispersion medium allows for uniform dispersion of the alumina particles in the resin composition and then improvement of the storage stability of the resin composition. The dispersion medium is not particularly limited as long as curing of the resin composition is not obstructed. The dispersion medium may be reactive or non-reactive.

A monomer such as a (meth)acryloyl compound and an epoxy compound can be used as the reactive dispersion medium. A monomer such as a (meth)acryloyl compound and an epoxy compound can be used. Examples of the (meth)acryloyl compound include 1,6-hexanediol di(meth)acrylate, EO-modified bisphenol A di(meth)acrylate, polyethylene glycol di(meth)acrylate, PO-modified bisphenol A di(meth)acrylate, polypropylene glycol di(meth)acrylate, polytetramethylene glycol di(meth)acrylate, 2-hydroxy-3-phenoxypropyl acrylate, (meth)acrylic acid adduct of propylene glycol diglycidyl ether, (meta)acrylic acid adduct of tripropylene glycol diglycidyl ether, and (meth)acrylic acid adduct of glycerin diglycidyl ether. (Meth)acryloyl compounds exemplified by the monomer described later may be used as the dispersion medium.

A ketone solvent such as methyl ethyl ketone (MEK) and methyl isobutyl ketone (MIBK), an alcohol solvent such as methanol (MeOH) and propylene glycol monomethyl ether (PGME), or an ester solvent such as propylene glycol monomethyl ether acetate (PGMEA) may be used as a non-reactive dispersion medium. In the case of the non-reactive dispersion medium, the resin composition may be prepared by mixing the base resin with the alumina particles dispersed in the dispersion medium and then removing a part of the dispersion medium. The alumina particles dispersed in the non-reactive dispersion medium are easy to reduce shrinkage on curing of the resin composition, compared with the alumina particles dispersed in the reactive dispersion medium.

The alumina particles dispersed in the dispersion medium remain to be dispersed in the resin layer after curing of the resin composition. When a reactive dispersion medium is used, the alumina particles are mixed with the dispersion medium in the resin composition and are incorporated in the resin layer with the dispersion condition maintained. When a non-reactive dispersion medium is used, at least a part of the dispersion medium evaporates and disappears from the resin composition, but the alumina particles remain in the resin composition with the dispersion condition remained and are also present in the cured resin layer with the dispersion condition remained. Electron microscope observation shows that the alumina particles present in the resin layer are in the condition of dispersion of the primary particle.

The shape of the alumina particles is not limited. The alumina particles may be spherical particles, chain particles, irregularly shaped particles, plate-shaped, or fiber-shaped.

From the viewpoint of increasing the Young's modulus of the resin layer, the average primary particle size of the alumina particles may be 5 nm or more and 800 nm or less, 10 nm or more and 750 nm or less, 20 nm or more and 700 nm or less, or 25 nm or more and 650 nm or less. The average primary particle size can be measured with image analysis of electron microscope pictures and a light scattering method, for example. The dispersion medium in which the primary particle of the alumina particles is dispersed appears to be visually transparent when the diameter of the primary particle is small. When the diameter of the primary particle is relatively large (40 nm or more), the dispersion medium in which the primary particle is dispersed appears to be clouded, but the precipitate is not observed.

The content of the aluminum oxide (alumina particles) in the resin composition is 1% by mass or more and 60% by mass or less, and may be 5% by mass or more and 55% by mass or less, or 10% by mass or more and 50% by mass or less based on the total amount of the resin composition. The content of the aluminum oxide of 1% by mass or more allows for easy formation of the resin layer having excellent lateral pressure characteristics. The content of the aluminum oxide of 60% by mass or less allows for easy formation of the tough resin layer having excellent storage stability of the resin composition.

(Base Resin)

The base resin according to the present embodiment contains an oligomer comprising urethane (meth)acrylate, a monomer, and a photopolymerization initiator. (Meth)acrylate means an acrylate or a methacrylate corresponding to it. The same applies to (meth)acrylic acid.

An oligomer obtained by reacting a polyol compound, a polyisocyanate compound, and a hydroxyl group-containing (meth)acrylate compound can be used as the urethane (meth)acrylate.

Examples of the polyol compound include polytetramethylene glycol, polypropylene glycol, and bisphenol A-ethylene oxide addition diol. Examples of the polyisocyanate compound includes 2,4-tolylene diisocyanate, 2,6-tolylene diisocyanate, isophorone diisocyanate, and dicyclohexylmethane 4,4′-diisocyanate. Examples of the hydroxyl group-containing (meth)acrylate compound include 2-hydroxyethyl (meth)acrylate, 2-hydroxybutyl (meth)acrylate, 1,6-hexanediol mono(meth)acrylate, pentaerythritol tri(meth)acrylate, 2-hydroxypropyl (meth)acrylate, and tripropylene glycol mono(meth)acrylate.

As a catalyst for synthesizing a urethane (meth)acrylate, an organotin compound is generally used. Examples of the organotin compound include dibutyltin dilaurate, dibutyltin diacetate, dibutyltin maleate, dibutyltin bis(2-ethylhexyl mercaptoacetate), dibutyltin bis(isooctyl mercaptoacetate), and dibutyltin oxide. From the viewpoint of easy availability or catalyst performance, it is preferable that dibutyltin dilaurate or dibutyltin diacetate be used as catalyst.

When the urethane (meth)acrylate is synthesized, lower alcohols having 5 or less carbon atoms may be used. Examples of the lower alcohols include methanol, ethanol, 1-propanol, 2-propanol, 1-butanol, 2-butanol, 2-methyl-2-propanol, 1-pentanol, 2-pentanol, 3-pentanol, 2-methyl-1-butanol, 3-methyl-1-butanol, 2-methyl-2-butanol, 3-methyl-2-butanol, and 2,2-dimethyl-1-propanol.

From the viewpoint of increasing the Young's modulus of the resin layer, the oligomer may further comprise an epoxy (meth)acrylate. As an epoxy (meth)acrylate, an oligomer obtained by reacting a compound having a (meth)acryloyl group with an epoxy resin having two or more glycidyl groups can be used.

As the monomer, a monofunctional monomer having one polymerizable group or a multifunctional monomer having two or more polymerizable groups can be used. A monomer may be used by mixing two or more monomers.

Examples of the monofunctional monomer include (meth)acrylate monomers such as methyl (meth)acrylate, ethyl (meth)acrylate, propyl (meth)acrylate, n-butyl (meth)acrylate, sec-butyl (meth)acrylate, tert-butyl (meth)acrylate, isobutyl (meth)acrylate, n-pentyl (meth)acrylate, isopentyl (meth)acrylate, hexyl (meth)acrylate, heptyl (meth)acrylate, isoamyl (meth)acrylate, 2-ethylhexyl (meth)acrylate, n-octyl (meth)acrylate, isooctyl (meth)acrylate, isodecyl (meth)acrylate, lauryl (meth)acrylate, 2-phenoxyethyl (meth)acrylate, 3-phenoxybenzyl (meth)acrylate, phenoxydiethylene glycol acrylate, phenoxypolyethylene glycol (meth)acrylate, 4-tert-butylcyclohexanol (meth)acrylate, tetrahydrofurfuryl (meth)acrylate, benzyl (meth)acrylate, dicyclopentenyl (meth)acrylate, dicyclopentenyloxyethyl (meth)acrylate, dicyclopentanyl (meth)acrylate, nonylphenol polyethylene glycol (meth)acrylate, nonylphenoxy polyethylene glycol (meth)acrylate, and isobornyl (meth)acrylate; carboxyl group-containing monomers such as (meth)acrylic acid, (meth)acrylic acid dimer, carboxyethyl (meth)acrylate, carboxypentyl (meth)acrylate, and ω-carboxy-polycaprolactone (meth)acrylate; heterocycle containing (meth)acrylates such as N-(meth)acryloyl morpholine, N-vinyl pyrrolidone, N-vinyl caprolactam, N-acryloylpiperidine, N-methacryloylpiperidine, N-(meth)acryloylpyrrolidine, 3-(3-pyridine) propyl (meth)acrylate, and cyclic trimethylolpropane formal acrylate; maleimide monomers such as maleimide, N-cyclohexyl maleimide, and N-phenyl maleimide; amide monomers such as (meth)acrylamide, N, N-dimethyl (meth)acrylamide, N, N-diethyl (meth)acrylamide, N-hexyl (meth)acrylamide, N-methyl (meth)acrylamide, N-isopropyl (meth)acrylamide, N-butyl (meth)acrylamide, N-methylol (meth)acrylamide, and N-methylolpropane (meth)acrylamide; aminoalkyl (meth)acrylate monomers such as aminoethyl (meth)acrylate, aminopropyl (meth)acrylate, N, N-dimethylaminoethyl (meth)acrylate, and tert-butylaminoethyl (meth)acrylate; and succinimide monomers such as N-(meth)acryloyloxymethylene succinimide, N-(meth)acryloyl-6-oxyhexamethylene succinimide, and N-(meth)acryloyl-8-oxyoctamethylene succinimide.

Examples of the multifunctional monomer include ethylene glycol di(meth)acrylate, polyethylene glycol di(meth)acrylate, polypropylene glycol di(meth)acrylate, neopentyl glycol di(meth)acrylate, tripropylene glycol di(meth)acrylate, di(meth)acrylate of alkylene oxide adduct of bisphenol A, tetraethylene glycol di(meth)acrylate, hydroxypivalic acid neopentyl glycol di(meth)acrylate, 1,4-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, isopentyl diol di(meth)acrylate, 3-ethyl-1, 8-octanediol di(meth)acrylate, EO adduct of bisphenol A di(meth)acrylate, trimethylol propane tri(meth)acrylate, trimethylol octane tri(meth)acrylate, trimethylol propane polyethoxy tri(meth)acrylate, trimethylol propane polypropoxy tri(meth)acrylate, trimethylol propane polyethoxy polypropoxy tri(meth)acrylate, tris[(meth)acryloyloxyethyl] isocyanurate, pentaerythritol tri(meth)acrylate, pentaerythritol polyethoxy tetra(meth)acrylate, pentaerythritol polypropoxy tetra(meth)acrylate, pentaerythritol tetra(meth)acrylate, ditrimethylol propane tetra(meth)acrylate, dipentaerythritol tetra(meth)acrylate, dipentaerythritol penta(meth)acrylate, dipentaerythritol hexa(meth)acrylate, and caprolactone-modified tris[(meth)acryloyloxyethyl] isocyanurate.

The photopolymerization initiator can be appropriately selected from known radical photopolymerization initiators and used. Examples of the photopolymerization initiator include 1-hydroxycyclohexyl phenyl ketone (Omnirad 184 manufactured by IGM Resins), 2,2-dimethoxy-2-phenylacetophenone, 1-(4-isopropylphenyl)-2-hydroxy-2-methylpropan-1-one, bis(2,6-dimethoxybenzoyl)-2,4,4-trimethylpentylphosphine oxide, 2-methyl-1-[4-(methylthio)phenyl]-2-morpholino-propan-1-one (Omnirad 907 manufactured by IGM Resins), 2,4,6-trimethylbenzoyldiphenylphosphine oxide (Omnirad TPO manufactured by IGM Resins), and bis(2,4,6-trimethylbenzoyl) phenylphosphine oxide (Omnirad 819, manufactured by IGM Resins).

The resin composition may further contain a silane coupling agent, a photoacid generator, a leveling agent, an antifoaming agent, and an antioxidant.

The silane coupling agent is not particularly limited as long as it does not disturb curing of the resin composition. Examples of the silane coupling agent include tetramethyl silicate, tetraethyl silicate, mercaptopropyl trimethoxysilane, vinyltrichlorosilane, vinyltriethoxysilane, vinyltris(β-methoxy-ethoxy)silane, β-(3,4-epoxycyclohexyl)-ethyltrimethoxysilane, dimethoxydimethylsilane, diethoxydimethylsilane, 3-acryloxypropyltrimethoxysilane, γ-glycidoxypropyltrimethoxysilane, γ-glycidoxypropylmethyldiethoxysilane, γ-methacryloxypropyltrimethoxysilane, N-(β-aminoethyl)-γ-aminopropyltrimethoxysilane, N-(β-aminoethyl)-γ-aminopropyltrimethyldimethoxysilane, N-phenyl-γ-aminopropyltrimethoxysilane, γ-chloropropyltrimethoxysilane, γ-mercaptopropyltrimethoxysilane, γ-aminopropyltrimethoxysilane, bis-[3-(triethoxysilyl)propyl]tetrasulfide, bis-[3-(triethoxysilyl)propyl]disulfide, γ-trimethoxysilylpropyldimethylthiocarbamyl tetrasulfide, and γ-trimethoxysilylpropyl benzothiazyl tetrasulfide.

An onium salt having A⁺B⁻ structure may be used as the photoacid generator. Examples of the photoacid generator include sulfonium salts such as UVACURE 1590 (manufactured by Daicel-Cytec Co., Ltd.), CPI-100P, 110P (manufactured by San-Apro Ltd.) and iodonium salts such as Omnicat 250 (manufactured by IGM Regins Co., Ltd.), WPI-113 (manufactured by FUJIFILM Wako Pure Chemical Corporation), and Rp-2074 (manufactured by Rhodia Japan Ltd.).

The resin composition according to the present embodiment is preferably used as the secondary coating material for the optical fiber. Using the resin composition according to the present embodiment for the secondary resin layer, the coating resin layer having excellent lateral pressure characteristics can be formed.

<Optical Fiber>

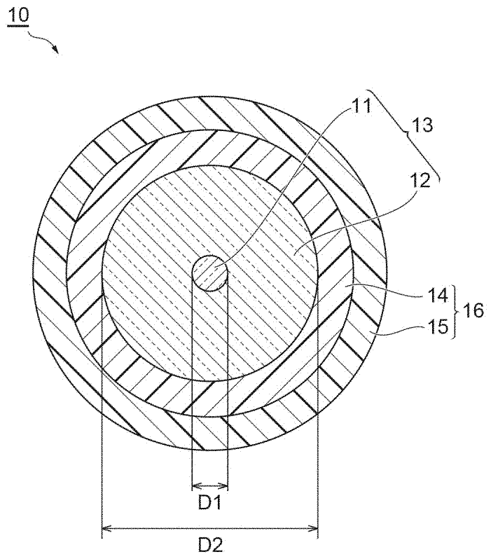

FIG. 1 is a schematic cross-section diagram showing an example of the optical fiber according to the present embodiment. The optical fiber 10 comprises the glass fiber 13 comprising the core 11 and the cladding 12, and the coating resin layer 16 comprising the primary resin layer 14 provided on the outer periphery of the glass fiber 13 and the secondary resin layer 15.

The cladding 12 surrounds the core 11. The core 11 and the cladding 12 mainly comprise glass such as silica glass, germanium-added silica glass can be used, for example, in the core 11, and pure silica glass or fluorine-added silica glass can be used in the cladding 12.

In FIG. 1, for example, the outside diameter (D2) of the glass fiber 13 is about 100 μm to 125 μm, and the diameter (D1) of the core 11 constituting the glass fiber 13 is about 7 μm to 15 μm. The thickness of the coating resin layer 16 is typically about 22 μm to 70 μm. The thickness of each of the primary resin layer 14 and the secondary resin layer 15 may be about 5 μm to 50 μm.

When the outside diameter (D2) of the glass fiber 13 is about 125 μm and the thickness of the coating resin layer 16 is 60 μm or more and 70 μm or less, the thickness of each of the primary resin layer 14 and the secondary resin layer 15 may be about 10 μm to 50 μm, for example, the thickness of the primary resin layer 14 may be 35 μm and the thickness of the secondary resin layer 15 may be 25 μm. The outside diameter of the optical fiber 10 may be about 245 μm to 265 μm.

When the outer diameter (D2) of the glass fiber 13 is about 125 μm and the thickness of the coating resin layer 16 is 27 μm or more and 48 μm or less, the thickness of each of the primary resin layer 14 and the secondary resin layer 15 may be about 10 μm to 38 μm, for example, the thickness of the primary resin layer 14 may be 25 μm and the thickness of the secondary resin layer 15 may be 10 μm. The outside diameter of the optical fiber 10 may be about 179 μm to 221 μm.

When the outside diameter (D2) of the glass fiber 13 is about 100 μm and the thickness of the coating resin layer 16 is 22 μm or more and 37 μm or less, the thickness of each of the primary resin layer 14 and the secondary resin layer 15 may be about 5 μm to 32 μm, for example, the thickness of the primary resin layer 14 may be 25 μm and the thickness of the secondary resin layer 15 may be 10 μm. The outside diameter of the optical fiber 10 may be about 144 μm to 174 μm.

The resin composition according to the present embodiment can be applied to the secondary resin layer. The secondary resin layer can be formed by curing a resin composition comprising the above base resin and the aluminum oxide. Accordingly, the lateral pressure characteristics of the optical fiber can be improved.

A method of manufacturing the optical fiber according to the present embodiment comprises an application step of applying the above resin composition onto the outer periphery of a glass fiber composed of a core and a cladding; and a curing step of curing the resin composition by irradiation with ultraviolet rays after the application step.

The Young's modulus of the secondary resin layer is preferably 1150 MPa or more at 23° C., more preferably 1200 MPa or more and 2700 MPa or less, and further preferably 1300 MPa or more and 2600 MPa or less. The Young's modulus of the secondary resin layer of 1150 MPa or more is easy to improve the lateral pressure characteristics, and the Young's modulus of 2700 MPa or less can provide proper toughness to the secondary resin layer so that a crack or the like in the secondary resin layer is hard to occur.

The aluminum oxide dispersed in the dispersion medium remains to be dispersed in the resin layer after curing of the resin layer. When a reactive dispersion medium is used, the aluminum oxide is mixed with the dispersion medium in the resin composition and is incorporated in the resin layer with the dispersion condition maintained. When a non-reactive dispersion medium is used, at least a part of the dispersion medium evaporates and disappears from the resin composition, but the aluminum oxide remains in the resin composition with the dispersion condition remained and is also present in the cured resin layer with the dispersion condition remained. Electron microscope observation shows that the aluminum oxide present in the resin layer is in the condition of dispersion of the primary particles.

The primary resin layer 14 can be formed by curing a resin composition comprising a urethane (meth)acrylate, a monomer, a photopolymerization initiator and a silane coupling agent. Prior art techniques can be used for a resin composition for the primary resin layer. A urethane (meth)acrylate, a monomer, a photopolymerization initiator and a silane coupling agent may be appropriately selected from compounds exemplified in the above base resin. The resin composition constituting the primary resin layer has composition different from the base resin forming the secondary resin layer.

A plurality of optical fibers may be arranged in parallel and integrated with a ribbon resin to form an optical fiber ribbon. The resin composition according to the present disclosure can also be used as a ribbon resin. This can improve the lateral pressure characteristics of the optical fiber ribbon as in the case of the optical fiber.

### EXAMPLES

Hereinafter, the results of evaluation test using Examples and Comparative Examples according to the present disclosure will be shown, and the present disclosure is described in more detail. The present invention is not limited to these examples.

[Resin Composition for a Secondary Resin Layer]

(Oligomer)

A urethane acrylate (UA) obtained by reacting polypropylene glycol having a molecular weight of 600, 2,4-tolylene diisocyanate, and hydroxyethyl acrylate, and an epoxy acrylate (EA) were prepared as the oligomers.

(Monomer)

Isobornyl acrylate (trade name “IBXA” of Osaka Organic Chemical Industry Co. Ltd.), and tripropylene glycol diacrylate (TPGDA, trade name “Viscoat #310HP” of Osaka Organic Chemical Industry Co. Ltd.) were prepared as the monomers.

(Photopolymerization Initiator)

As the photopolymerization initiator, 1-hydroxycyclohexyl phenyl ketone and 2,4,6-trimethylbenzoyldiphenylphosphine oxide were prepared.

(Aluminum Oxide)

Alumina sols including alumina particles (Al-1 to Al-5) having surface conditions and average primary particle sizes shown in Table 1 were prepared as aluminum oxide. Hydrophobic alumina particles had a methacryloyl group.

TABLE 1

| | | | | | |
|---|---|---|---|---|---|
| Alumina particles | Al-1 | Al-2 | Al-3 | Al-4 | Al-5 |
| Dispersion medium | MEK | MEK | MEK | MEK | MEK |
| Surface condition | Hydrophobic | Hydrophobic | Hydrophobic | Hydrophobic | Hydrophilic |
| Average primary | 30-50 | 100-200 | 200-300 | 400-600 | 200-300 |
| particle size (nm) | | | | | |

(Resin Composition)

40 parts by mass of UA, 20 parts by mass of EA, 10 parts by mass of IBXA, 30 parts by mass of TPGDA, 0.5 parts by mass of 2,4,6-trimethylbenzoyldiphenylphosphine oxide, and 0.5 parts by mass of 1-hydroxycyclohexyl phenyl ketone were mixed to prepare a base resin. Thereafter, the alumina sol was mixed with the base resin so as to have the content of the alumina particles shown in Table 2 or Table 3, and then most of MEK as a dispersion medium was removed under reduced pressure to prepare resin compositions of Examples and Comparative Examples, respectively. The total amount of the resin composition and the total amount of the cured product of the resin composition may be considered to be the same.

(Stability of Resin Composition)

The resin composition was stirred while heating at 45° C. for 30 minutes and then allowed to stand at room temperature for 1 hour to visually confirm the appearance.

(Young's Modulus)

The resin composition was applied onto a polyethylene terephthalate (PET) film by using a spin coater, and then cured by using an electrodeless UV lamp system (“VPS 600 (D valve)” manufactured by Heraeus) at a condition of 1000±100 mJ/cm² to form a resin layer having a thickness of 200±20 μm on the PET film. The resin layer was peeled off from the PET film to obtain a resin film. A resin film was punched into a dumbbell shape of JIS K 7127 type 5 and was pulled under a condition of 23±2° C. and 50±10% RH, a tensile speed of 1 mm/min and a distance between marked lines of 25 mm using a tensile tester, and a stress-strain curve was obtained. Young's modulus was determined by 2.5% secant line.

[Production of Optical Fiber]

(Resin Composition for Primary Resin Layer)

Urethane acrylate obtained by reacting polypropylene glycol having a molecular weight of 4000, isophorone diisocyanate, hydroxyethyl acrylate, and methanol was prepared as the oligomer. The resin composition for the primary resin layer was produced by mixing 75 parts by mass of urethane acrylate, 12 parts by mass of nonylphenol EO-modified acrylate, 6 parts by mass of N-vinylcaprolactam, 2 parts by mass of 1,6-hexanediol diacrylate, 1 part by mass of 2,4,6-trimethylbenzoyldiphenylphosphine oxide, and 1 part by mass of 3-mercaptopropyltrimethoxysilane.

(Optical Fiber)

The resin composition for the primary resin layer and the resin composition of Examples or Comparative Examples for the secondary resin layer were applied onto the outer periphery of a 125 μm diameter glass fiber composed of a core and a cladding, and then the resin composition was cured by irradiation with ultraviolet rays and a primary resin layer having a thickness of 35 μm and a secondary resin layer having a thickness of 25 μm around the outer periphery thereof were formed to produce an optical fiber. A linear speed was 1500 m/min.

(Lateral Pressure Characteristics)

The transmission loss of light having a wavelength of 1550 nm when the optical fiber 10 was wound into a single layer on a bobbin having a diameter of 280 mm whose surface was covered with sandpaper was measured by an OTDR (Optical Time Domain Reflectometer) method. In addition, the transmission loss of light having a wavelength of 1550 nm when the optical fiber 10 was wound into a single layer on a bobbin having a diameter of 280 mm without sandpaper was measured by the OTDR method. Difference in the measured transmission loss was obtained and the lateral pressure characteristics was judged to be “OK” when the transmission loss difference was 0.6 dB/km or less, and the lateral pressure characteristics was judged to be “NG” when the transmission loss difference was over 0.6 dB/km. In Comparative Example 2, cracks occurred in the resin layer when winding the optical fiber around the bobbin, and the lateral pressure characteristics could not be evaluated.

TABLE 2

| | Example 1 | Example 2 | Example 3 | Example 4 | Example 5 | Example 6 | Example 7 |
|---|---|---|---|---|---|---|---|
| Alumina | AI-2 | AI-2 | AI-2 | AI-2 | AI-2 | AI-2 | AI-2 |
| particles | | | | | | | |
| Content of | 1 | 10 | 20 | 30 | 40 | 50 | 60 |
| alumina | | | | | | | |
| particles | | | | | | | |
| (% by mass) | | | | | | | |
| Stability of | Dispersion | Dispersion | Dispersion | Dispersion | Dispersion | Dispersion | Dispersion |
| resin | | | | | | | |
| composition | | | | | | | |
| Young's | 1300 | 1400 | 1500 | 1800 | 2000 | 2300 | 2600 |
| modulus | | | | | | | |
| (MPa) | | | | | | | |
| Lateral | OK | OK | OK | OK | OK | OK | OK |
| pressure | | | | | | | |
| characteristics | | | | | | | |

TABLE 3

| | | | | Comparative | Comparative | Comparative |
|---|---|---|---|---|---|---|
| | Example 8 | Example 9 | Example 10 | Example 1 | Example 2 | Example 3 |
| Alumina | AI-1 | AI-3 | AI-4 | AI-5 | AI-3 | — |
| particles | | | | | | |
| Content of | 40 | 30 | 30 | 30 | 70 | — |
| alumina particles | | | | | | |
| (% by mass) | | | | | | |
| Stability of resin | Dispersion | Dispersion | Dispersion | Precipitation | Dispersion | — |
| composition | | | | | | |
| Young's modulus | 2200 | 1700 | 1500 | 1500 | 2800 | 1100 |
| (MPa) | | | | | | |
| Lateral pressure | OK | OK | OK | NG | NG | NG |
| characteristics | | | | | | |

### REFERENCE SIGNS LIST

10: Optical fiber, 11: Core, 12: Cladding, 13: Glass fiber, 14: Primary resin layer, 15: Secondary resin layer, 16: Coating resin layer.

1: A resin composition for coating an optical fiber, comprising:
a base resin containing an oligomer comprising urethane (meth)acrylate, a monomer, and a photopolymerization initiator; and
hydrophobic aluminum oxide,
wherein a content of the aluminum oxide is 1% by mass or more and 60% by mass or less based on a total amount of the resin composition.

2: The resin composition according to claim 1, wherein an average primary particle size of the aluminum oxide is 5 nm or more and 800 nm or less.

3: The resin composition according to claim 1, wherein the oligomer further comprises epoxy (meth)acrylate.

4: A secondary coating material for an optical fiber, comprising the resin composition according to claim 1.

5: An optical fiber comprising:
a glass fiber comprising a core and a cladding;
a primary resin layer being in contact with the glass fiber and coating the glass fiber; and
a secondary resin layer coating the primary resin layer,
wherein the secondary resin layer comprises a cured product of the resin composition according to claim 1.

6: An optical fiber comprising:
a glass fiber comprising a core and a cladding;
a primary resin layer being in contact with the glass fiber and coating the glass fiber; and
a secondary resin layer coating the primary resin layer,
wherein the secondary resin layer comprises alumina particles and a content of the alumina particles is 1% by mass or more and 60% by mass or less based on a total amount of the secondary resin layer.

7: A method for manufacturing an optical fiber, comprising:
an application step of applying the resin composition according to claim 1 onto an outer periphery of a glass fiber comprising a core and a cladding; and
a curing step of curing the resin composition by irradiation with ultraviolet rays after the application step.

8: A secondary coating material for an optical fiber, comprising the resin composition according to claim 2.

9: A secondary coating material for an optical fiber, comprising the resin composition according to claim 3.

10: An optical fiber comprising:
a glass fiber comprising a core and a cladding;
a primary resin layer being in contact with the glass fiber and coating the glass fiber; and
a secondary resin layer coating the primary resin layer,
wherein the secondary resin layer comprises a cured product of the resin composition according to claim 2.

11: An optical fiber comprising:
a glass fiber comprising a core and a cladding;
a primary resin layer being in contact with the glass fiber and coating the glass fiber; and
a secondary resin layer coating the primary resin layer,
wherein the secondary resin layer comprises a cured product of the resin composition according to claim 3.

12: A method for manufacturing an optical fiber, comprising:
an application step of applying the resin composition according to claim 2 onto an outer periphery of a glass fiber comprising a core and a cladding; and
a curing step of curing the resin composition by irradiation with ultraviolet rays after the application step.

13: A method for manufacturing an optical fiber, comprising:
an application step of applying the resin composition according to claim 3 onto an outer periphery of a glass fiber comprising a core and a cladding; and
a curing step of curing the resin composition by irradiation with ultraviolet rays after the application step.
